(19) United States
(12) Patent Application Publication
(10) Pub. No.: US 2005/0116198 A1
(43) Pub. Date: Jun. 2, 2005

(54) Stabilisation of particulate material using wool grease

(76) Inventors: Douglas Ryan, Burpengary (AU); Gary Stuart Heyden, Park Ridge (AU); Kenneth Allan MacKenzie, Mt. Glorious (AU)

Correspondence Address: MOORE & VAN ALLEN PLLC, P.O. BOX 13706, Research Triangle Park, NC, 27709, US

(21) Appl. No.: 10/494,801

(22) PCT Filed: Nov. 8, 2001
(86) PCT No.: PCT/AU01/01437

(51) Int. Cl. C09K 3/22

(52) U.S. Cl. 252/88.1

(57) ABSTRACT

An aqueous composition containing wool grease and a cationic or nonionic surfactant can be used to stabilise a wide range of particulate materials. The composition can be used to stabilise road materials, earth banks, coal piles, loose sand and dams. A binder such as a lignin sulphonate may be added to provide improved properties.

### FIELD OF THE INVENTION

This invention is directed to the use of wool grease or derivatives or components thereof to stabilise particulate material such as soils, sand, fines such as dust fines, and other particulate material which may be subject to erosion such as erosion caused by wind, rain, traffic and the like, and to loss of strength caused by prolonged contact with water.

### BACKGROUND ART

Stabilisation of particulate material, and particularly soils and the like, is critical to prevent erosion. Stabilisation is required for roads and especially road base material, dams such as earth dams, sand dunes, earth banks and particularly earth banks which are in contact with flowing water, seawalls and particularly earth seawalls, road banks, areas of uncovered soil or sand, and the like. Stabilisation is also required for fines to prevent or suppress dust contamination, an example of which comprise coal or ore stockpiles that always have a percentage of fines in the stockpile.

A particular type of stabilisation of soils etc is to attempt to improve the hydrophobic properties of the soil, or to improve the waterproofing properties of the soil. If this can be achieved, the soil is less susceptible to water erosion. A number of chemical techniques to achieve these are known and are given below.

It is well known to treat soil with cationic surfactants such as aliphatic and aromatic amines and amine salts. The cationic surfactant render the soil particles more hydrophobic, reduces swelling in the soil, and flocculate the very fine clay particles. However, these compounds are quite expensive, eventually leach from the particulate matter and have some toxicity problems, unpleasant odours, and may require special handling procedures.

Petroleum asphalt, and similar type bitumen residues have been used for many years as admixtures with soil to improve stability under wet conditions. A difficulty with this type of product is that it requires either heating to make the product sufficiently fluid for rapid and inefficient mixing with the soil, or requires dilution with rather expensive solvents such as gasoline. The mixture is quite toxic to the environment, and is formed from a nonrenewable source. Careful handling procedures are required, and the mixture can be highly flammable. Bitumen residues can contain carcinogenic compounds. 5 The solvent is usually toxic to plant life making the mixture unsuitable for earth bank stabilisation where plants are to be grown.

Portland cement is known as an additive to many types of soils to improve the water-resistance of the soil and to improve its load bearing strength. These admixtures are known as “soil cement”, and consist typically of between 5% to 15% of cement to soil. A disadvantage with Portland cement is the high-energy cost required to manufacture the cement. Portland cement is extremely moisture sensitive and requires careful handling and storage procedures to prevent it from deteriorating before use. This makes Portland cement less suitable for use in third world countries as a soil stabilisation agent where the infrastructure to store and transport the cement may not be very advanced.

It is known to treat soil with lime to impart water resistance and stability. Lime is however quite caustic to the environment, and can damage or kill adjacent plant life, and contaminate nearby water sources. Lime, and especially quick lime requires careful handling procedures as it can cause skin burns.

Phosphoric acid has been used as a soil stabiliser. The acid is unsuitable for use with highly alkaline soils, and requires careful handling procedures. Phosphoric acid is also quite expensive. Phosphates can leach from soils to assist with algal blooms in nearby bodies of water.

Physical barriers to improve water proofing of soils are well known. These can include injection of grout into the soil, topical treatment of the soil with a resinous material (for instance asphalt), and injecting polymeric settable materials into the soil. Physical barriers require careful placement of the material.

Lignin sulphonate has been used in a dispersant to stabilise soil in a road base. Lignin sulphonate is a waste byproduct of paper mills and comprises a polymer found in wood. The inexpensive nature of lignin sulphonate has made it attractive for use in the stabilisation of road base material.

Lignin sulphonate has been combined with other additives to improve its stabilising ability. For instance, it is known to use a combination of lignin sulphonate together with ethers of dialkyl phenols and fatty acid esters of polyglycerol, which is a widely available dispersant material. It was found that lignin sulphonate by itself did not distribute equally through the soil particles. Lignin Sulphonate is highly water-soluble and eventually leaches from soils thus reducing its stabilizing effect.

Epoxy resin esters of unsaturated fatty acids have also been mixed with soil to provide stabilisation. The fatty acid is typically a tall oil fatty acid, which is a byproduct of the wood pulp industry.

These chemicals typically have problems with toxicity, handling, storage and transportation, cost, and potential poisoning of adjacent waterways, plant and animal life.

The above chemicals and additives have other disadvantages. For instance, many of these chemicals or additives cannot be effectively used with soils that have excess acidity or alkalinity, soils having a high mineral salt content. And soils that have a varied composition such as a large particle range size, and mixtures of organic and inorganic particles. Many of the above chemicals and additives are also not effective to waterproof soils where the soil is in contact with salt water, water that is excessively acidic or alkaline, and hard water (containing high amounts of dissolved minerals).

Some of the above chemicals cannot be effectively incorporated with or added to known soil stabilising additives such as lignin sulphonates or cements, which is a distinct disadvantage.

Wool grease is very well known and is a natural product that is extracted from sheep wool. Wool grease is a fatty, pale yellow wax that coats the fibers of sheep's wool and yields lanolin.

Australian wool, prior to scouring, contains up to 30% wool grease. The amount depends on the breed of the animal, age and nutritional status. The distribution of wool grease along the fibre is uneven and the grease near the tip of the fibre helps to bind the fibres together in staples. The high grease content of wool is unique among the animal fibres that normally contain less than 5% grease. Raw wool from sheep and other animals contains many constituents considered contaminants by wool processors and the contaminants must be substantially removed from the wool prior to use. The type and amount of contaminants can vary according to breed, nutrition, environment and position of the wool on the animal. The main contaminants are a solvent-soluble fraction called wool grease, protein material, a water-soluble fraction (largely perspiration salts collectively termed suint), dirt and vegetable matter in the form of burrs and seeds from pastures. A fleece may contain up to 30% by weight of contaminants, depending on the animal, so it is important that the wool is treated before use.

The first process of preparing wool involves the removal of the contaminants and this process is termed scouring.

In traditional wool scouring, the contaminants on the wool, mainly grease, dirt, suint and protein material are washed from the wool fibre using water and detergents. The contaminants remain in the wastewater either in emulsion or suspension (grease, dirt, protein) or in solution (suint). Extraction of the wastewater produces grease contaminated with detergent and suint and is termed wool grease.

An alternative to the aqueous scouring of skins after tannage is the removal of the wool grease using solvent dry cleaning technology. The conventional processing of Australian woolskins frequently requires the dry cleaning of the tanned product to remove lipids from the skin. The same procedure can be used to remove the modified wool grease at the same time. Both perchlorethylene and white spirit give good results. Using conventional dry cleaning plants that utilise a distillation system for solvent recycling the only technical issue that arises is the accumulation of recovered grease in the distillation still. The mass of grease present on the wool is 2-3 times that extracted from the leather and will therefore require the still to be emptied more frequently. The advantage of solvent cleaning of the woolskins is that the C.O.D. and B.O.D. loading of the aqueous effluent is significantly lowered.

The grease (technically a wax) consists of fatty acids and complex monohydric alcohols. The alcohols are sterols, triterpene alcohols and wax alcohols. The major constituent is cholesterol that accounts for 30-40% of the unsaponifiable material in the wool grease. The fatty acids are derived from four main series—the normal fatty acids, the iso-acids, the branched-chain acids and hydroxy acids.

Suint is the water-soluble material on the wool and consists largely of salts sweated by the sheep. Soluble salts of carboxylic acids make up 65% of the constituents of suint which also contains minor amounts of lactic, hippuric and succinic acids, urea and lanaurin, a bile pigment which gives suint its characteristic brown-red colour.

The removal of grease from scour liquor is advantageous because the grease is of commercial value, its removal increases the useful life of the scour liquor and grease removal reduces the pollution load of effluent discharged from a scour plant and renders it more amenable to further treatment. Many different techniques have been developed for the removal of grease from scour liquor, and of these the most common is the use of continuous sludge discharge centrifuges. After being fed through a settling tank or hydrocyclone to remove heavy solids the scour liquor is passed through a centrifuge that removes as a cream the grease mixed with water. The cream after heating and storage can be separated with a simple disc separator.

The oldest method of removal and one still in use is acid cracking. Sulphuric acid is added to the scour liquor to adjust the pH to 3.5 at which it cracks and the grease-rich phase is removed by filtration or flotation and the residual liquor is neutralised and discharged. A low quality grease may be extracted from the sludge removed from the liquor, however, as the cracking is only suitable for non-detergent scouring systems.

Also widely practiced is the use of salts such as ferrous sulphate, alum and calcium chloride to crack the grease/water emulsion.

Wool grease has been used in a number of commercial applications. Wool grease or the purified components thereof has been widely used in the cosmetics industry. Components of wool grease have also been used as a plant growth stimulant. Wool grease has been used as a combustible material when mixed with other material such as wood shavings. It has also been used as a rust treatment preparation when used in an emulsion with phosphoric acid. Wool grease has been used as a lubricant in drilling and grinding techniques, and as a corrosion inhibiting composition. These known uses of wool grease use the lubricant properties of the grease, and the passivation properties of the grease.

Prior use of wool grease for stabilization of soils required the adoption of soaps of fatty acids in highly alkaline medium to carry the wool grease into the soil (U.S. Pat. No. 813,389). Others used insoluble calcium or aluminium fatty acid soaps with lanolin soaps and mineral based oils/waxes. (U.S. Pat. No. 561,266). Another (U.S. Pat. No. 575,479) used ammonia salts of waxes, resins or fatty acids (oleic, stearic, palmitic, oleine) then rendered them insoluble using a multivalent metal salt such as aluminium, iron, copper, chromium. Wool wash liquid containing wool grease and soap has been applied to soils then precipitated with a trivalent metal salt to reduce its solubility in the soil. U.S. Pat. No. 605,057, uses a combination of soaps of fatty acids (such as wool grease fatty acid) by heating in combination with a soap of rosin acids and a hydrophobic substance such as a bitumen, a heavy metal (litharge) and a filler to create a waterproof plastic compound used in construction The use of soaps however, does not render reliable stabilization as it breaks down, leaches from the soil and its effectiveness is short lived in the soil. Excess trivalent metal salt is required to react with the soaps applied to the soil. The excess trivalent metal salts applied to soils are usually soluble and any excess leaching to the environment are very toxic. For example the addition of trivalent metal salts such as aluminium salts are very soluble at a pH less than 7 and very toxic to the environment. Similarly lead salts applied to soils are now banned.

### OBJECT OF THE INVENTION

The present invention is directed to the use of wool grease or derivatives or components thereof applied to particulate matter and particularly using a cationic or nonionic (or both) surfactant to provide a stabilising effect on particulate material. In particular, it is found that wool grease when mixed with soil or sand particles provides a waterproofing effect, or makes the mixture more hydrophobic. The invention is also directed to a composition that contains wool grease, a cationic or nonionic surfactant together with a binding agent and which is found to be particularly effective as a soil stabilising agent.

It is an object of the invention to provide a composition and a method that may overcome the abovementioned disadvantages or provide the public with a useful or commercial choice.

In one form, the invention resides in a method for stabilising particulate material, the method comprising addition of wool grease or a derivative or components thereof using a cationic or nonionic surfactant to the particulate material. Throughout the specification and claims, the term wool grease can include derivatives or components thereof.

The wool grease may be added to the particulate material in an amount from 0.001%-10% by weight. The surfactant may be a cationic or nonionic type (or both) in an amount from 1 to 20% by weight.

The particulate material may comprise soil, sand, dust, coal and coal fines, mineral ores, mineral concentrates and the like.

The wool grease/surfactant mixture can be added to the particulate material to prevent water from entering the surface or body of particles and/or to stabilise the particles. In one form, the wool grease functions to increase the hydrophobic characteristic of the particulate matter. The cationic surfactants function to emulsify the wool grease, allow the wool grease to surround the particulate matter then react ionically with the particulate matter to then no longer render surfactant functions and allow the wool grease to remain around the particulate material with out washing from the body of particulate material. Cationic surfactants also render the particles more hydrophobic, reduce swelling of the soil and flocculates fine clay particles. Nonionic surfactants serve to emulsify the wool grease and act as a wetting agent in the particulate matter to allow the wool grease to pass deeper into the body of particulate material.

The wool grease may be added to the particulate material using a mixture with a cationic or nonionic surfactant or a combination of both. If required, water or water containing surfactant mixtures may be added to the particulate material to form an aqueous solution or emulsion then the wool grease added and mixed.

The amount of wool grease in the particulate material can be between 1%-50%.

The wool grease/surfactant mixture can be mixed into or throughout the particulate material, added to the outside of the particulate material or otherwise added to the particulate material. The application may be made by pouring, spraying, brushing, flooding, and by other application means. For smaller volumes, the particulate material may be added to the wool grease or a solution thereof and mixed together by any suitable type of mixing means which may be manual, mechanical or electrical.

The wool grease/surfactant mixture may be incorporated with other compounds or additives including cement, fly ash, lignin sulphonates, dispersants, and the like. The relative proportions typically depend on the type of particulate matter and the desired use.

In another form, the invention resides in a composition for addition to particulate material, the composition comprising wool grease/surfactant mixture and a binding agent for the particulate material. Typically, the binding agent is a lignin sulphonate. The composition may be in the form of a pourable or sprayable liquid and may therefore contain water, water containing compositions, or other liquids such as non-aqueous liquids. The amount of the binding agent may be between 0.1%-30% of the composition, and the amount of Wool grease may be between 0.01%-20% of the composition, and the amount of cationic or nonionic surfactant may be between 1%-20%.

### Best Mode

### EXAMPLE 1

### Stabilisation of Road Materials

200 grams of Wool grease was emulsified with 8 grams of cationic surfactant (diamine type), 1 ml of hydrochloric acid and 200 ml of water to create a nominal 50% emulsion. This mixture was mixed with base aggregate for use under a roadway and water to create an aggregate soil mixture containing 5% wool grease and optimum soil compaction moisture—nominally 6%. The aggregate soil mixture was placed in a soil test cylinder and compacted into a core to field strength for roadways. Additional layers of aggregate (treated or untreated) can be added over the top or under the treated layer. The core made from the treated road base material was immersed in water and it was observed that the core remained at full strength after total immersion in water for six months. Conversely a core made from the same material but without the wool grease/cationic mixture collapsed within 30 minutes when fully immersed in water.

### EXAMPLE 2

### Stabilisation of Road Materials

The procedure of for example 1 was copied except that an addition of 1% fly ash and 1% cement was made. These treated cores remained very hard even after continuous immersion for 17 months.

### EXAMPLE 3

### Stabilisation of Road Materials

A similar core using the same road base material of example 1 was created whereby only the top half of the core contained the wool grease/cationic mixture and the bottom half was left untreated but similarly compacted. This core was immersed to less than half its height in water. Within 30 minutes water was drawn into the bottom half of the core and it had collapsed while the top half had remained unaffected by water even after 8 weeks. This demonstrated that capillary action into the treated zone was stopped.

The treated aggregate exhibited good hydrophobic properties and prevented wetting of the road base and thus loss of strength.

Other cores prepared similarly using a variety of soil types from heavy clays to sandstones and crusher dust using a variety of wool grease levels from 0.13 to 20% performed similarly with full and continuous immersion for periods days to weeks. One such core demonstrated that even after full continuous immersion for 3 months the core contained less than 1% moisture content.

### EXAMPLE 4

### Effect of Temperature

Two treated cores made by example 1 and two untreated cores were placed in a freezer at −10_{θ}C for 1 week. After this period the untreated cores expanded due to the water freezing and increasing in volume. The treated cores did not change shape and remained hard. This demonstrated that the invention has application in cold environments to prevent frost heave in roads. When using a diamine type cationic surfactant, no cationic surfactant could be detected (<1 mg/L) in the water from cores fully immersed when the surfactant was used in conjunction with wool grease in the 4-8% range.

### EXAMPLE 5

### Effect of Temperature

The cores of example 2 containing fly ash and cement, at the rate of 1-2% fly ash and 1-2% cement were used and no visible change was noted.

### EXAMPLE 6

### Preparation of Emulsifying Composition

200 grams of Wool grease was mixed with 8 grams of cationic surfactant (diamine type), 1 ml of hydrochloric acid and 200 ml of water to create a nominal 50% emulsion.

### EXAMPLE 7

### Preparation of Emulsifying Composition Containing a Binder

To the emulsion of example 6 was added a binder in the form of a lignin sulphonate the ratio of wool grease to lignin sulphonate being greater than 0.2 to 1 respectively.

### EXAMPLE 8

### Leaching Rate of Emulsifying Composition Containing a Binder

The composition of example 7 was mixed with base aggregate for use under a roadway and water to create an aggregate soil mixture containing 5% wool grease and optimum soil compaction moisture—nominally 6%. The aggregate soil mixture was placed in a soil test cylinder and compacted into a core. It was found that the leachability of the binder was reduced by up to A small roadway was prepared by scouring up the roadway to a depth of 100 mm and adding water to achieve the optimum moisture content (nominally 6%). Lignin sulphonate was added and mixed using traditional road making methods using a grader and roller. A mixture of wool grease (nominal 50% emulsion) and cationic surfactant (diamine type) was added to the top 50 mm mixed by the blading from a grader then rolled smooth. After 3 months with heavy trucks passing over the roadway the road surface has not broken up and when water is applied to the top of the roadway, it still runs off the surface. The amount of dust emission from the road has reduced to negligible levels.

### EXAMPLE 10

### Erosion Prevention

A driveway experiencing washout and loss of soil was treated with a 30% wool grease water emulsion containing 4% cationic surfactant, by applying to the soil after scouring then rolling flat. After a heavy down pour of rain the surface of the road remained dry and no loss of soil or scouring of the driveway surface.

### EXAMPLE 11

### Water Course and Earth Bank Stabilisation

A Wool grease/cationic surfactant mixture (40% wool grease, 4% surfactant) was applied to soil around a small watercourse used as a drainage channel to prevent the soil from wetting and losing strength. The treated soil was also found to be much less susceptible to water erosion with no visible scouring from the water.

### EXAMPLE 12

### Coal Piles/Ore Piles/Sand Piles/Quarry Soil Piles

A small plot of soil (2 sq.metres) containing sand-clay mixture was leveled and treated by the addition of a 40% Wool grease/cationic surfactant mixture to the top surface by spraying. Pegs were pushed into the surface to allow 5 mm between the top of the pegs and the soil surface. Similarly an equal size plot was prepared without the addition of the wool grease/cationic surfactant mixture. The two plots were left and exposed side by side for 2 months to the effects of wind and sun. The treated plot lost less than 1 mm of soil from the surface whereas the untreated soil lost 3-4 mm from the surface.

It was found that the treatment provided significant reduction of dust and loss of product through wind erosion.

### EXAMPLE 13

### Sand Stabilisation

The above experiment was set up but using coarse sand with a particle distribution between 0.5 mm and 2 mm. The sand was treated by spraying as in example 12 (plot 1). A control plot 600 mm by 600 mm was left untreated (plot 2). The treated sand was found to be more hydrophobic and water was prevented from entering into the sand layer and instead ran over the surface of the sand. The surface was firmer than the untreated plot.

A third treatment plot was created as above but incorporating 5% lignin sulphonate in the sand to form a hard layer having a thickness of around 10 mm. A fourth plot was set up similar to the third plot but no wool grease/cationic surfactant was added. Again a hard layer having a thickness of around 30 mm was formed when water was evaporated from the surface. When all four plots were left to dry, water was poured into the surface. Plot 1 allowed water to run off the surface but the surface was still relatively soft but more firm than plot 2 (untreated) which allowed the water to pass into the body of the sand. Plot 3 allowed the water to run off the surface and the surface of the sand remained very firm. Plot 4 water passed into the surface of the sand as it dissolved the lignin sulphonate. The surface was very soft similar to plot 2 but when the surface dried, it again became very firm. A fifth plot was created similar to plot 1 except 1% nonionic surfactant was used in conjunction with 4% cationic surfactant. This performed similar to plot 1 but allowed the hydrophobic layer to go deeper into the body of sand.

While not wishing to be bound by theory, it appears that the combination of a binding agent such as lignin sulphonate together with the wool grease/cationic mixture provides a surprising and unexpected advantage to the invention. It appears that the wool grease composition by itself is effective in reducing wind and water erosion, but creates only a thin layer that can be more easily disturbed. However, the layer is stable against rain, surface water, and wind erosion. Lignin sulphonate by itself creates a good hard layer that can be between 1-3 cm thick, but the layer is not particularly stable against rain or water and can soften and degrade. When wool grease/cationic surfactant mixture is combined with lignin sulphonate, a good thick hard layer can be obtained which is relatively stable against rain, surface water and wind erosion and can last for a considerable amount of time.

### EXAMPLE 14

### Dams

A soil containing sand and clay was mixed together to form a combined soil to create a permeability of 1 metre of water passing through a 200 mm thickness of soil in 24 hours to simulate a leaking dam situation. The soil after treatment was placed in a clear plastic tube 50 mm diameter and 1200 mm long. A control sample with no treatment was similarly created. The treated soil was treated by mixing with water containing a 5% solution of the (40%) wool grease/cationic surfactant mixture described above. Enough of this treatment solution was added to the soil to create a very wet soil but not so that it would slump or flow. The same amount of water was added to the control tube. Air was passed into the top of the tubes to allow the soils to dry. Water was then placed gently in the top of the tubes to prevent disturbance of the soil surface and filled to the 1 metre level. After 2 days the control tube was empty of water while the treatment tube had not lost any water. After a month the treatment tube lost 38 mm but it was thought this was due to evaporation despite the top being covered. The soil in the treatment tube did not show visible signs of wetting.

It should be appreciated that various other changes and modifications may be made to the embodiment described without departing from the spirit and scope of the invention.

1. An aqueous composition for stabilising particulate material, the composition comprising wool grease, and a surfactant selected from the group consisting of a cationic surfactant or nonionic surfactant.

2. The composition of claim 1 comprising between 1%-70% wool grease and 1-20% surfactant.

3. The composition of claim 2 additionally comprising a binder.

4. The composition of claim 3, wherein the binder is a lignin sulphonate.

5. The composition of claim 4, wherein the amount of lignin sulphonate is between 0.1%-30%.

6. A stabilised particulate composition comprising the composition of claim 1 together with particulate material.

7. The composition of claim 6 containing between 0.01%-20% wool grease.

8. The composition of claim 7 wherein the particulate material is selected from the group consisting of aggregate, clay, sandstone, crusher dust, soil, sand, coal, coal fines, mineral ores.

9. The composition of claim 8 wherein the particulate material additionally comprises fly ash.

10. The composition of claim 9 wherein the particulate material additionally comprises cement.

11. A stabilised particulate composition comprising the composition of claim 3 together with particulate material.

12. The composition of claim 11, wherein the binder is lignin sulphonate.

13. The composition of claim 12 containing between 0.01%-20% wool grease.
